(19) United States
(12) Patent Application Publication
(10) Pub. No.: US 2024/0237848 A1
(43) Pub. Date: Jul. 18, 2024

(54) AUTOMATIC BEVERAGE VENDING MACHINE

(71) Applicant: RHEAVENDORS INDUSTRIES S.P.A., Como (IT)

(72) Inventors: Fabio BRUZZESE, Como (IT); Claudio MAGGIONI, Como (IT); Roberto RIVA, Como (IT); Gianluca PIATTI, Como (IT); Carlo Moreno MOLINATI, Como (IT); Claudio BELTRAME, Como (IT)

(21) Appl. No.: 18/560,193

(22) PCT Filed: May 10, 2022
(86) PCT No.: PCT/IB2022/054319

§ 371 Date: Nov. 10, 2023

(30) Foreign Application Priority Data
May 10, 2021 (IT) 102021000011930

(51) Int. Cl. A47J 31/52; A47J 31/34

(52) U.S. Cl. CPC A47J 31/52; A47J 31/34

(57) ABSTRACT

In an automatic beverage vending machine, the components of an assembly for producing and dispensing the beverages are housed, at least partially, within a chamber of the vending machine and are supported within the same chamber by a drawer coupled to a structure of the vending machine in a sliding manner between two end of stroke positions, one of which is inserted into the chamber and one of which is at least partially extracted from the same chamber; the drawer having a base wall on which a part of the components for producing and dispensing beverages are rested directly or by means of interface structures, and being provided with a front flap door, which supports another part of the components for producing beverages.

### CROSS-REFERENCE TO RELATED APPLICATIONS

This patent application claims priority from Italian patent application No. 102021000011930 filed on May 10, 2021, the entire disclosure of which is incorporated herein by reference.

### TECHNICAL FIELD OF THE INVENTION

The present invention relates to an automatic beverage vending machine, in particular coffee, tea, cappuccino and hot chocolate, to which the following discussion will explicitly refer without thereby losing generality.

### STATE OF THE ART

As is known, automatic beverage vending machines are normally connected to the water supply network and generally comprise tanks containing soluble products, mixing chambers for mixing water with a soluble product or with a mixture of soluble products, dispensers and conduits for connecting the tanks to the mixing chambers and the mixing chambers to the dispensing nozzles.

The known automatic beverage vending machines then typically also comprise an assembly for producing espresso coffee, at least one solenoid valve for controlling the delivery of water into each mixing chamber, dosing means for measuring the exact amount of soluble product required to obtain a specific beverage, and a vacuum cleaner for cleaning the dispensing conduits and the mixing chambers from any residues that may be deposited as a result of dispensing the beverage.

In the automatic beverage vending machines of the prior art, the parts listed above and others that are not mentioned, all known as “components for producing beverages”, are mounted in a specific or dedicated compartment.

In order to meet the ever-increasing need for particularly compact automatic beverage vending machines, the components are placed in close contact with each other or at least partially overlapping each other.

The Applicant has been able to ascertain in practice that the arrangement of the components in side-by-side and partially overlapping positions allows, on the one hand, for the realization of compact automatic beverage vending machines, but, on the other hand, it actually makes it extremely difficult and often impossible for technicians to access the automatic beverage vending machines from the front in order to carry out any scheduled maintenance or to carry out repair interventions or for simple inspection or minor interventions on the automatic beverage vending machines without having to completely remove some of these components or parts thereof, thus creating access aisles or compartments. This inevitably leads to particularly long intervention times and machine downtimes, which generate inevitable costs and lost revenue.

On the other hand, access from the rear of the vending machine is often impossible because of the particular layout of the automatic beverage vending machine itself, and requires in any case moving or advancing the entire automatic beverage vending machine, which is more difficult the smaller the space around the automatic beverage vending machine and/or if the automatic beverage vending machine is located in areas of strong passage, as is often the case in public places.

The problem described above is partly solved by particular types of automatic beverage vending machines, in which the assembly for producing espresso coffee can be extracted from the front independently of the other components. However, these types of automatic beverage vending machines only allow a simple extraction of the assembly for producing coffee, leaving the problem for the rest of the components untouched.

US 2004/144800 describes an automatic beverage vending machine in which a movable element carrying a part of the components is slidable between an inserted position and an extracted position. The movable element supports a flap door, which carries another part of components and is hinged to the movable element to rotate around a hinge axis parallel to a sliding direction of the movable element and is therefore movable in its overturned position only when the movable element is arranged in its extracted position.

### SUBJECT AND SUMMARY OF THE INVENTION

Aim of the present invention is to realize an automatic beverage vending machine, which allows to solve in a simple and economical way the above-mentioned problems and, in particular, an automatic beverage vending machine whose construction characteristics allow immediate access to each of the various components indicated above without the need to disassemble others or parts thereof in order to access them.

A further aim of the present invention is to realize an automatic beverage vending machine whose construction characteristics allow easy access to the various components in a short time, in safety and in order to keep the components themselves on board the automatic beverage vending machine so as to facilitate and speed up the operations of putting the vending machine back into operation.

According to the present invention, an automatic beverage vending machine is realized, as claimed in claim 1.

### BRIEF DESCRIPTION OF THE DRAWINGS

FIG. 1 is a perspective view, with parts removed for clarity's sake, of a preferred embodiment of an automatic beverage vending machine realized according to the dictates of the present invention.

FIGS. 2 and 3 are similar figures to FIG. 1 and show the vending machine of FIG. 1 in two different inspection and/or maintenance conditions.

FIGS. 4 to 6 show, in perspective view and to an enlarged scale with parts removed for clarity's sake, an assembly of FIGS. 1 to 3 arranged in a functional position and, respectively, in two different inspection/maintenance positions.

### DETAILED DESCRIPTION OF PREFERRED EMBODIMENTS OF THE INVENTION

The present invention will now be described in detail with reference to the accompanying figures to allow a skilled person to make and use it. Various modifications of the embodiment described will be immediately clear to the skilled person and the general principles disclosed can be applied to other embodiments and applications without departing from the protection scope of the present invention, as defined in the enclosed drawings. Therefore, the present invention shall not be limited to the shown and described embodiments, but it must be granted the widest protection scope in accordance with the features disclosed and claimed.

Unless otherwise defined, all the herein used technical and scientific terms have the same meaning commonly used by the ordinary skilled in the art of the present invention. In case of conflict, the present invention, including definitions provided, will be binding. Furthermore, the examples are provided for merely illustrative purposes and must not be regarded as limiting.

In order to case the understanding of the herein described embodiments, reference will be made to some specific embodiments and a specific language will be used to describe them. The terminology used in the present document aims at describing only particular implementations and is not intended to limit the scope of the present invention.

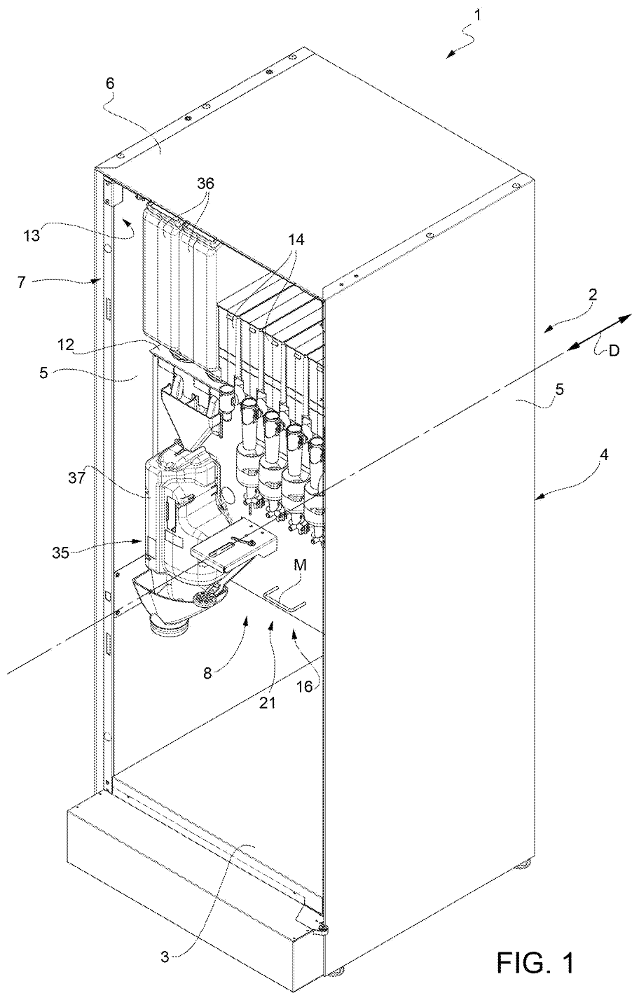

In FIGS. 1 to 3, reference number 1 denotes an automatic beverage vending machine as a whole.

The automatic beverage vending machine 1 comprises an external casing or container 2, in turn, comprising, a floor support base 3, a rear wall 4, two side walls 5 and an upper wall 6 facing the support base 3.

The support base 3 and the side 5 and upper 6 walls delimit a front or anterior opening 7 facing the rear wall 4 and for the access from the front to the container 2.

The container 2 delimits a chamber 8, inside which a beverage preparation assembly 10 is at least partially housed, in general and, in turn, comprising a plurality of components, per se known and not described in detail, and generically indicated by 11.

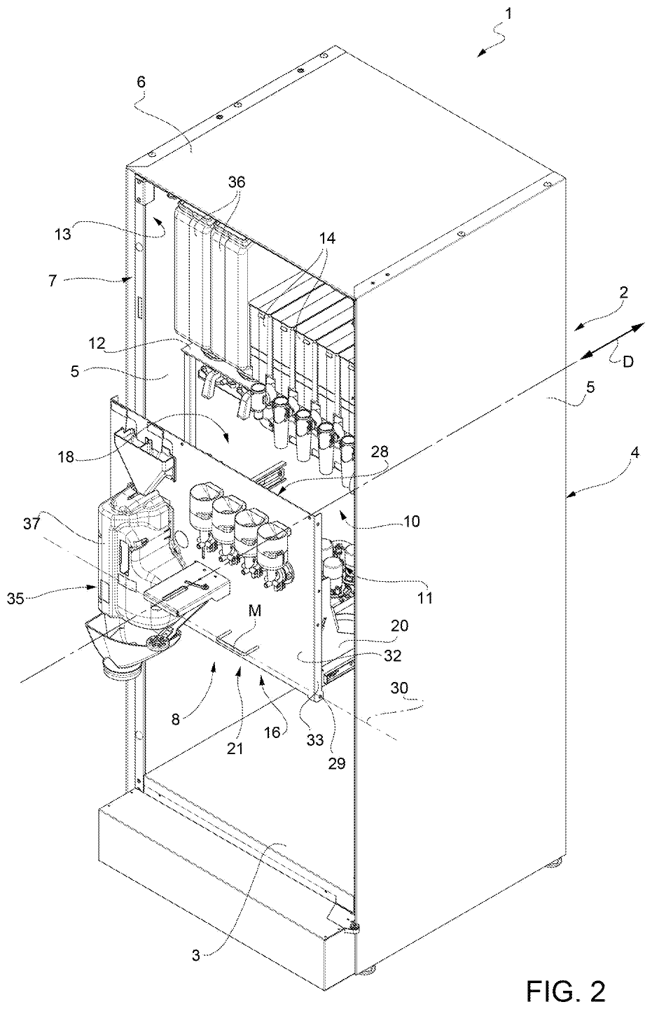

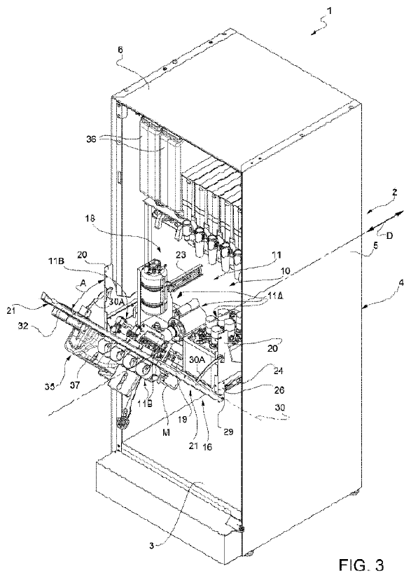

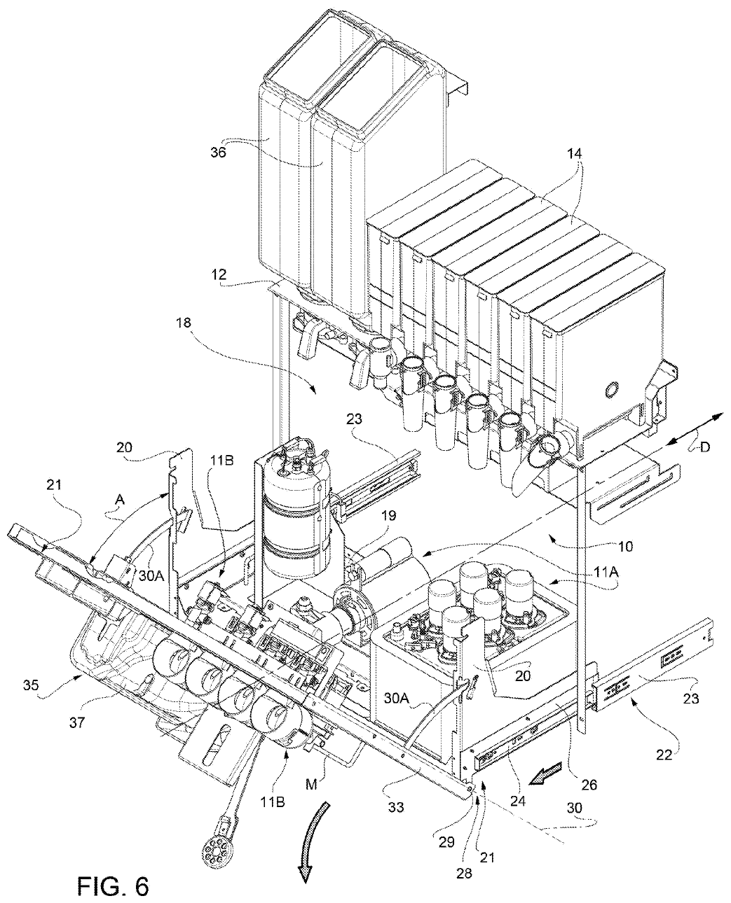

With reference to FIGS. 2 and 3 and, in particular, FIG. 6, the assembly 10 comprises a fixed shelf 12, which extends horizontally between the two side walls 5, in a position facing the upper wall 6 to delimit with the upper wall 6 itself a compartment 13.

The compartment 13 houses a plurality of tanks 14 for storing soluble products, which are arranged to rest on the shelf 12.

According to a variant not shown, the shelf 12 is coupled to the remaining part of the container 2 directly, for example to the side walls 5 by means of a guide and slide device which allows the shelf 12 to slide to and from the back wall 4 between a retracted position, in which it keeps the tanks 14 in one of their operational positions, and an advanced or extracted position, in which the tanks 14 extend through the opening 7 or completely outside of the container 2, so that they can be inspected or cleaned or replaced if necessary.

Again, with reference to FIG. 2 and with reference to FIGS. 3 to 6, the automatic beverage vending machine 1 further comprises a sliding drawer 16 arranged between the shelf 12 and the base 3.

The drawer 16 delimits with parts of the container 2 a compartment 18 (FIG. 1) for housing at least part of the components 11 of the assembly 10.

In particular, the drawer 16 comprises a base plate 19, two sidewalls 20 and an anterior door 21.

The drawer 16 is coupled to the side walls 20 by means of a pair of guide and slide assemblies 22 for sliding in opposite directions in a direction D parallel to the walls 5 and 6 and orthogonal to the wall 4.

Each assembly 22 comprises a fixed guide 23 stably connected to the relative side wall 5 and a slide 24 sliding along the relative fixed guide 23.

Each slide 24 is fixed to the relative sidewall 20 directly or by the interposition of respective attachment structures 26 each stably connected to a relative sidewall 20, like in the example described and shown in particular in FIG. 6.

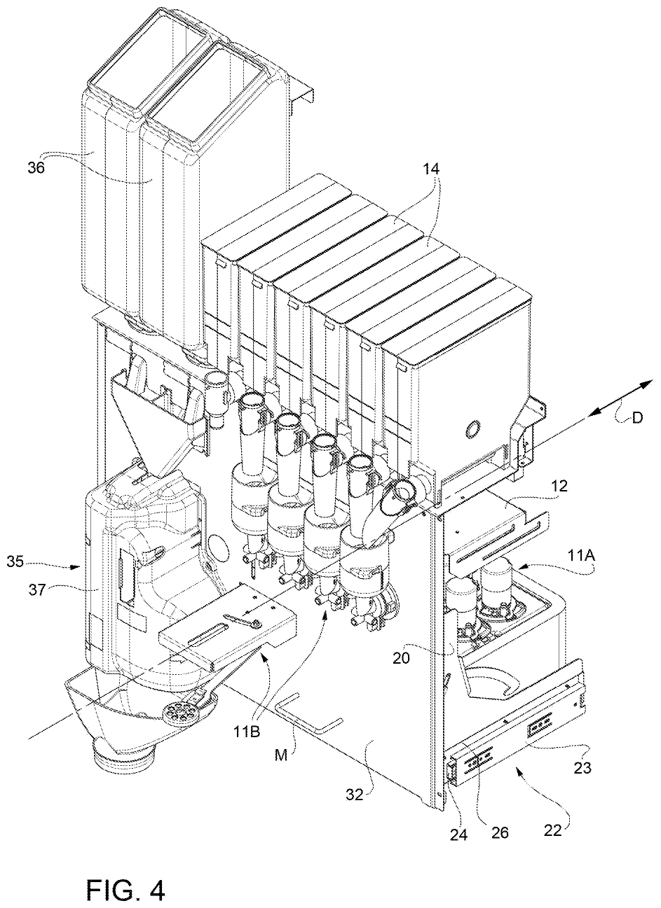

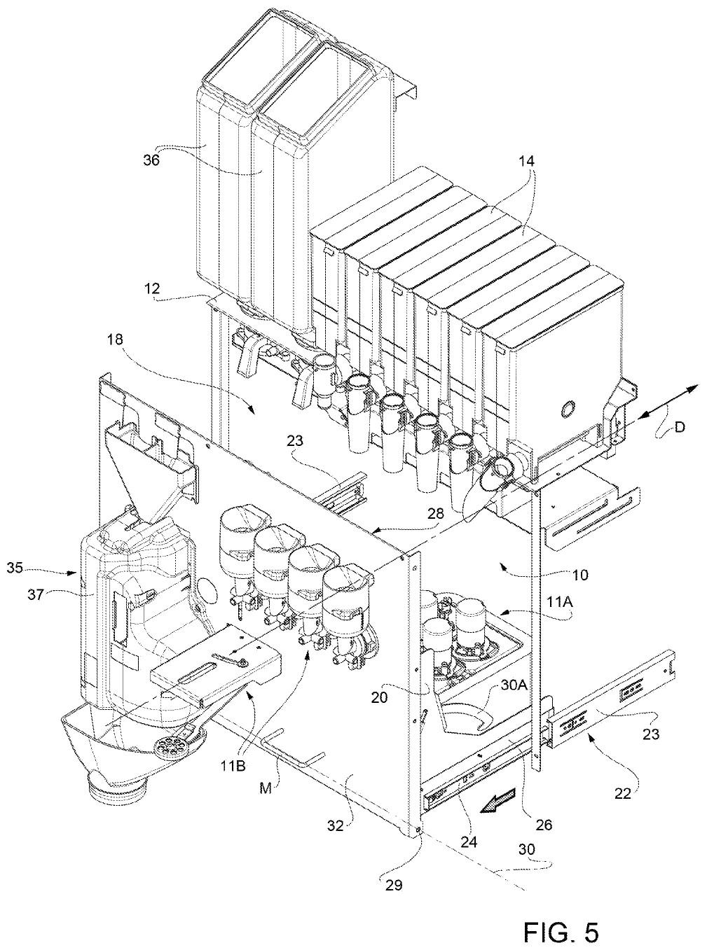

By acting on a handle M of the drawer 16, the assemblies 22 allow the drawer 16 to be moved along the direction D and to be arranged in a plurality of intermediate positions between two extreme end of stroke positions, of which one is operational retracted, shown in FIGS. 1 and 4, and one is extracted shown in FIGS. 5 and 6.

In both end of stroke positions, the drawer 16 is coupled to, and supported by, the container 2.

With reference to FIGS. 3 and 6, the door 21 is a movable door with respect to the base plate 19. In particular, the door 28 is a flap door and rotatable with respect to the base plate 19 and to the sidewalls 20 around a hinge axis 30 which is horizontal and orthogonal to the direction D. Conveniently, the hinge axis 30 is arranged adjacent to the base plate 19 and conveniently below the base plate 19.

Preferably, the door 21 is hinged to the structures 26 by means of a hinge device 28 having relative hinge pins 29.

The door 21 is movable between two extreme end of stroke angular positions, one of which is an operational vertical closing the compartment 18, shown in FIGS. 1, 2 4 and 5, and a forward overturned position, shown in FIGS. 3 and 6. When arranged in its overturned position, the door 21 is held in this position by lateral tie rods 30A and is rotated with respect to the vertical position by an angle A varying between 30° and 60° degrees and conveniently an angle of substantial 45°.

According to a variant not shown, the door 21, when arranged in its overturned position, forms an extension of the wall 19.

In the example described the door 21 comprises a flat panel 32 and two side brackets 33 for hinging to the relative structures 26 and forming parts of the hinge device 28.

However, the door 21 is made or hinged, the base plate 19 carries part of the components 11, indicated by 11A.

The components 11A are, in part, directly rested and made integral with the base plate 19 and, in part, supported by their own attachment structures to the base plate 19.

On the other hand, the door 21 carries another part of component 11, which are indicated by 11B.

The components 11A and 11B are distributed or positioned on the base plate 19 and, respectively, on one face or on both opposite faces of the door 21 in order to avoid interference between the components themselves during opening/closing of the door 21 and so as to prevent a technician from even partially decoupling one or more components 11 in order to be able to access other components 11.

In this way, when the drawer 16 is arranged in its extracted position it allows access to part of the components 11, while when also the door 21 is in its overturned position it is possible to inspect or act directly on each component 11, since the components 11 are visible and immediately accessible.

The intervention of an expert technician is therefore facilitated by the fact that he can easily act by partially or totally extracting the drawer 16 and, when necessary, by overturning the door 21 forward.

Any technical intervention is then facilitated by the fact that the drawer 16 and the relative components 11, regardless of the position of the drawer 16 in the direction D or of the door 21 with respect to the container 2, continue to be supported by the container 2, so that the technician is not required to exert a high degree of efforts in lifting and/or moving the drawer 16 and the relative components 11, of which, however, the technician(s) in charge of the vending machine would bear the responsibility if the drawer 16 were decoupled from the container 2.

In the example described, the back wall 19 and the door 21 are flat, however, they may be shaped and/or provided with recesses or projections, respectively, for housing or supporting/retaining one or more components 11.

Still with reference to the attached figures, the automatic beverage vending machine 1 also comprises an espresso coffee preparation assembly 35.

The assembly 35 comprises, in turn, containers 36 for the storage of coffee powder, resting on the shelf 12, and a brewing assembly 37, per se known, carried by the door 21 and, preferably, stably connected to an external surface of the same door 21 and projecting in a cantilever fashion therefrom.

Lastly, the vending machine 1 comprises a plurality of pipes connecting between them the various components 11 and shut-off and safety valves not visible in the attached figures for the sake of clarity but commonly known and now universally used in similar vending machines and by the same owner.

From the foregoing, it is evident that the use of a drawer with a flap door allows, with respect to the known solutions, on the one hand, to bring into view the entire attachment surface of the components 11, which is maximum when the door 21 forms an extension of the base wall 19, and, on the other hand, to distribute the components 11 so that it is possible to inspect and/or intervene on each of them or on most of them without the need to disassemble other components or parts of the same components. This makes it possible to drastically reduce intervention times and machine downtimes, which aspect is particularly appreciated when the vending machine is located in areas of strong passage or in areas with narrow stopping or maneuvering spaces.

The fact then that the drawer 16 always remains coupled to the container 2, regardless of its extraction condition, and therefore always supported by the container 2, allows the operator to carry out any inspection/maintenance/replacement intervention with minimum physical efforts, which efforts would be necessary and burdensome if the drawer 16 could be removed and moved away from the container 2.

Not only that, but the constant coupling of the drawer 16 to the container 2 allows the operator in charge of the vending machine to operate in total safety, as all parts in relative motion and all removable parts are always supported by the container 2.
Finally, it appears evident that in the vending machine 1, the technician can inspect and/or intervene at least on the components carried by the flap door 21 regardless of the position of the drawer 16 with respect to the container 2, including the position in which the drawer 16 is completely or partially inserted in the container 2 itself. The foregoing is allowed by the fact that the flap door 21 is hinged so as to rotate around a hinge axis 30 which is horizontal and orthogonal to the direction D of translation of the same drawer 16.

1. An automatic beverage vending machine, the vending machine comprising
a container delimiting a housing chamber and having an opening for access to said chamber;
a beverage preparation assembly having a plurality of components for producing beverages housed at least partly in said chamber and support means for said components;
said support means comprise a first support element for a first part of said components and a second support element for a second part of said components;
wherein said first support element comprises a horizontal wall, and in that at least part of said first components is directly rested on said wall or is coupled to said wall by the interposition of attachment structures to said wall;
guide and slide means, being interposed between the first support element and said container to allow said first support element a translation in a direction between two extreme end of stroke positions, one of which is inserted in said chamber and one of which is at least partially extracted from said chamber;
hinge means being interposed between said first support element and said second support element, for allowing the rotation of said second support element with respect to said first support element around a hinge axis which is horizontal and orthogonal to said direction, regardless of the position of said first support element between said extreme end of stroke positions;
wherein the second support element is movable between two extreme end of stroke angular positions, one of which is an operational vertical position for closing said chamber, and one of which is a forward overturned position;
wherein said first and said second support elements form part of an extractable drawer permanently coupled to said container and housing at least part of said components; said second support element forming a flap door of said drawer.

2. The vending machine according to claim 1, wherein said hinge means are configured to allow the rotation of said second support element with respect to said first support element around said hinge axis between two extreme end of stroke angular positions one of which is operational and at least partially closing said opening and the other is overturned for inspection/maintenance of at least part of said components, wherein the second support element is overturned and protrudes to the outside of the container.

3. The vending machine according to claim 1, wherein said second support element extends upwards from the first support element and in that said rotation axis is arranged adjacent to a lower end of said second support element.

4. (canceled)

5. The vending machine according to claim 1, wherein said second element comprises a flat front portion partially closing said opening and in that at least part of said second components are connected to a surface of said flat front portion facing said chamber.

6. The vending machine according to claim 1, wherein said second element comprises a flat front portion at least partially closing said chamber and in that at least part of said second components are connected to an external surface of said flat front portion.

7. (canceled)

8. The vending machine according to claim 1, wherein said guide and slide means comprise a pair of guides stably coupled to said container and a pair of slides each sliding along a relative said guide and stably coupled to said first element; said slides carrying part of said hinge means.

9. The vending machine according to claim 1, wherein said support means further comprise a shelf coupled to said container above said second support element; said shelf supporting storage tanks for soluble substances.

10. The vending machine according to claim 1, further comprising an assembly for producing espresso coffee; at least one component of said assembly for producing coffee being carried by said second support element.
